(19) United States
(12) Patent Application Publication
(10) Pub. No.: US 2017/0213479 A1
(43) Pub. Date: Jul. 27, 2017

(54) PCB PLUG-IN ELECTRONIC MODULE EXPERIMENT DEVICE

(71) Applicant: Rongchang Li, Foshan, Guangdong (CN)

(72) Inventor: Rongchang Li, Foshan, Guangdong (CN)

(21) Appl. No.: 15/329,256

(22) PCT Filed: Mar. 31, 2015
(86) PCT No.: PCT/CN2015/075567

§ 371 Date: Jan. 26, 2017

(30) Foreign Application Priority Data
Jul. 30, 2014 (CN) 201420428940.6

(51) Int. Cl. G09B 23/18; G09B 19/00

(52) U.S. Cl. CPC G09B 23/183; G09B 19/00

(57) ABSTRACT

Disclosed is a PCB plug-in electronic module experiment device, comprising a PCB module plugboard (20) and a number of PCB plug-in electronic modules (100), wherein the PCB module plugboard (20) is provided with lots of jacks (21); each PCB plug-in electronic module (100) comprises a PCB (11), a component (9) and a terminal socket (10) on the PCB, a plug (16), and an insulation pad (15) between the PCB (11) and the plug (16), each PCB plug-in electronic module (100) is secured to any jack on the PCB module plugboard by the plug; the electrical connection among multiple PCB plug-in electronic modules (100) can be established by connecting the terminal sockets via connectors to accomplish various electronic experiments. The device facilitates convenient and efficient introduction of components (in the form of plug-in modules) to experiments; moreover, simple circuit experiments and complex circuit experiments can be realized by the experiment device.

### FIELD OF THE INVENTION

The present invention relates to electronic experiment devices, in particular, to a PCB plug-in electronic module experiment device.

### BACKGROUND OF THE INVENTION

There are several electronic circuit experiment devices widely used hitherto and defects of them would be stated individually hereinafter:

Firstly, these popular experiment devices in China such as electronic tables, electronic kits, demo boards, electronic bricks, specific experiment boards, and module experiment boards are merely capable of performing interest-related electronic validation experiments under the direction of the enclosed instruction rather than general electronic experiments for developing the electronic products or training the innovative personnel on electronics, where the general electronic experiments refer to these experiments in which parameters of all components are adjustable during the process of experiments, the power supply of the circuit can be turned up or turned down, the circuit itself also is modifiable or adjustable, i.e. any simple or complex electronic circuit experiment can be accomplished thereby.

Secondly, the experiment devices like breadboards and perfboards appeared in the 70s of the last century when both the electronic components and electronic circuits are very simple are still in wide use in high school, colleges and universities in developed countries and Taiwan district because of the capacity of undertaking general experiments; the entries for all previous national undergraduate electronic design contests are all presented by the perfboards. However, the enterprises are thirsty for personnel grasping PCB experiment techniques because all the designs of electronic products can be only accomplished thereby. Therefore, the graduates being habituated to breadboards and perfboards must learn the PCB techniques from the very beginning to make themselves qualified for practical electronic innovation and electronic products development for enterprises.

Next, as for PCB integrated module experiments, functional PCB modules made on the basis of validated complex circuit designs are utilized to accomplish further complex experiments. But there are still some defects of the PCB integrated modules as follows: first, the lack of simple multifunctional modules disables the PCB integrated modules for simple circuit experiments; besides, even for the complex circuit experiments, the lack of the insulation pad, module plug and module plugboard is likely to cause circuit malfunctions like instability and poor contact.

In conclusion, the global vacancy of an advanced PCB plug-in module experiment device capable of substituting the backward breadboards and perfboards hitherto has badly delayed the development of the electronic products, the cultivation of the personnel on electronics and the popularization of electronic technology.

### SUMMARY OF THE INVENTION

The present invention provides a PCB plug-in electronic module experiment device, which facilitates convenient and efficient introduction of any component (in the form of plug-in module) to experiments; moreover, both simple circuit experiments and various complex circuit experiments can be realized by the PCB plug-in electronic module experiment device successfully.

The present invention provides a PCB plug-in electronic module experiment device, comprising a PCB module plugboard and a number of PCB plug-in electronic modules, wherein the PCB module plugboard is provided with a plenty of jacks, and each PCB plug-in electronic module comprises a PCB, a component and a terminal socket arranged on the PCB, a plug, and an insulation pad arranged between the PCB and the plug; each PCB plug-in electronic module can be secured to any jack on the PCB module plugboard by inserting the plug and removed therefrom by pulling out the plug; the electrical connection among multiple PCB plug-in electronic modules can be established by connecting the terminal sockets via connectors, so that various electronic experiments can be accomplished.

Preferably, the plug is matched to the jack in shape. Preferably, lower part of the plug is provided with an opening in the shape of “reversed Y” and posses extending elastic, so that self-lock of the plug is realized due to big friction between the plug and the internal surface of the jack, the plug-in and pull-out operation and the replacement of the plug is facilitated; besides, the internal middle part of the plug is provided with two screw guiding grooves, when it is necessary to keep the validated circuit for a long time or to move it for a long distance, a screw should be inserted from the bottom of the plug-in board and tightened in order to resist the possible vibration and loose so that the circuit system stays in effective contact and functions well.

Preferably, both the PCB and the insulation pad are provided with at least two screw holes correspondingly, and thereby the PCB is fastened onto the top surface of the insulation pad by the joint of screws and the screw holes.

Preferably, the bottom surface of the insulation pad is configured with a recess for receiving the top end of the plug while the top surface thereof is configured with a counterbore for the socket head screw, where the recess and the counterbore are holed through, the top end of the plug is configured with a first through hole, the plug is fastened to the bottom surface of the insulation pad by inserting the socket head screw into the counterbore and the first through hole orderly; between the socket head screw and the PCB is provided an insulation sticker to avoid short circuit of the PCB may caused by the socket head screw.

Preferably, each insulation pad is a flat pad in small size, which may be obtained by cutting from a general prefabricated module pad configured with equidistant counterbores on the top surface and equidistant square recesses for plugs on the bottom surface. Preferably, the PCB adopts various connecting approaches to connect to the external, including double quantity of plug-in terminals and corresponding bonding pads.

Preferably, each PCB plug-in electronic module can be any of a single multifunctional electronic module composed of a single component, a systematic functional electronic module composed of multiple components or a node module capable of substituting the public node.

The single multifunctional electronic module may be but is not limited to a 3-hole socket module, 6-hole socket module, 8-pin IC socket module, a variable resistor module and a node module; the systematic functional electronic module may be but is not limited to a RS232 serial communication module and a 51 single chip microcontroller socket module. The systematic functional electronic module also can adopt various connection approaches like line rows.

Preferably, the PCB module plugboard is rectangle, and a plenty of square jacks are located equidistantly on the PCB module plugboard, forming an M*N matrix. Comparing to the prior art, the PCB plug-in electronic module experiment device according to the present invention takes each module as an eligible component with certain functional features, input and output features, working features for use. When a certain experiment is to be conducted, the only thing needs to be done is selecting the modules with suited features from the module bank, plugging them into the plugboard, and connecting their input and output terminals, power supply, and testing instruments to each other by a few Dupont wires with reference to the experiment circuit diagram. When necessary, the experiment aim can be realized by modifying a part of circuits relating to a certain module thereof, and the other parts keeps operating normally all the time without any adjustment, which is highly efficient. When the experiment is completed, the experiment circuits are dismantled and the modules are restored in the module bank individually for reuse, and thereby the cost of time and money for the experiment are saved greatly. Particularly, PCB techniques are utilized from the experiment to production manufacture, the students in various colleges on electronics do not need to experiment on breadboards and perfboards at first and then transfer to PCB techniques in latter process, which is a waste of time for product development and personnel cultivation on electronics.

The advantages according to the present invention are as follows:

1. Universal and efficient, any component can act as a PCB plug-in electronic module through design and process, and participate in the experiment simply, besides, the PCB plug-in electronic module may be a multifunctional electronic module composed of a single component or a systematic functional electronic module, various combinations of these modules can be employed to accomplish the experiments with simple circuits or complex circuits in a highly efficient way;

2. PCB plug-in electronic module can be plugged into or pulled out from the PCB module plugboard optionally allowing a convenience replacement, especially when the multifunctional module composed of a single component and the node module are used for simple circuit experiments, the experiment layout can be arranged according to the principle diagram, making them two very similar, which facilitates to check the circuits, the instruments connection and malfunctions, the circuits stay in good contact and have anti-vibration property and thereby the efficiency of experiment is extremely high. Therefore, the present invention is helpful for prompting the juveniles' interest on electronics and the global popularization of electronics.

3. Either components or systematic functional circuits can be made as modules to participate the PCB plug-in module experiments; either simple circuits or complex circuits can be realized by the efficient experiment approach of PCB plug-in modules; the device according to the present invention is suited to training personnel on electronics during the electronic experiments step by step, so as to prepare for the global electronic technique revolution.

4. The combination of the insulation pad, module plug and module plugboard ensures good stability of the circuit during complex circuit experiments, fewer malfunctions and higher efficiency.

5. Using the general experiment techniques like PCB plug-in modules during the whole progress of the personnel cultivation on electronics from the beginning can avoid the use of these backward experiment techniques like breadboards and perfboards, and bridge the development of electronic products, the cultivation of the innovative personnel on electronics and the electronic design competition techniques directly with the PCB techniques required by the enterprises, prompting the electronic experiment techniques greatly.

### BRIEF DESCRIPTION OF THE DRAWINGS

FIG. 1 is a module layout diagram showing a simple circuit experiment (555 flashlight circuit) accomplished by a PCB plug-in electronic module experiment device according to the present invention (the upper is a schematic diagram of the circuit).

FIG. 2 is a diagram of the PCB plug-in electronic module.

FIG. 3 is an exploded diagram showing the structure of the PCB plug-in electronic module in detail.

FIGS. 4a and 4b are diagrams showing the connection between the plug and the insulation pad in FIG. 3.

FIGS. 5a and 5b are diagrams showing the structure of a prefabricated module pad forming the insulation pad in FIG. 3.

FIG. 6 is an enlarged partial diagram of A shown in FIG. 1.

FIG. 7 is a module layout diagram showing the layout of a complex circuit experiment (a single chip microcontroller communication circuit) accomplished by a PCB plug-in electronic module experiment device according to the present invention (the schematic diagram of the circuit is not shown).

### DETAILED DESCRIPTION OF PREFERRED EMBODIMENTS

Hereinafter, the embodiments of the present invention will be described distinctly and completely accompanied with the drawings. Obviously, described are only preferred embodiments of the present invention, which do not mean any limit to the scope of the protection of the present invention. It should be noted, any modification or improvement carried out by the skilled in the art within the principle of the present invention should be taken as within the scope of protection of the present invention.

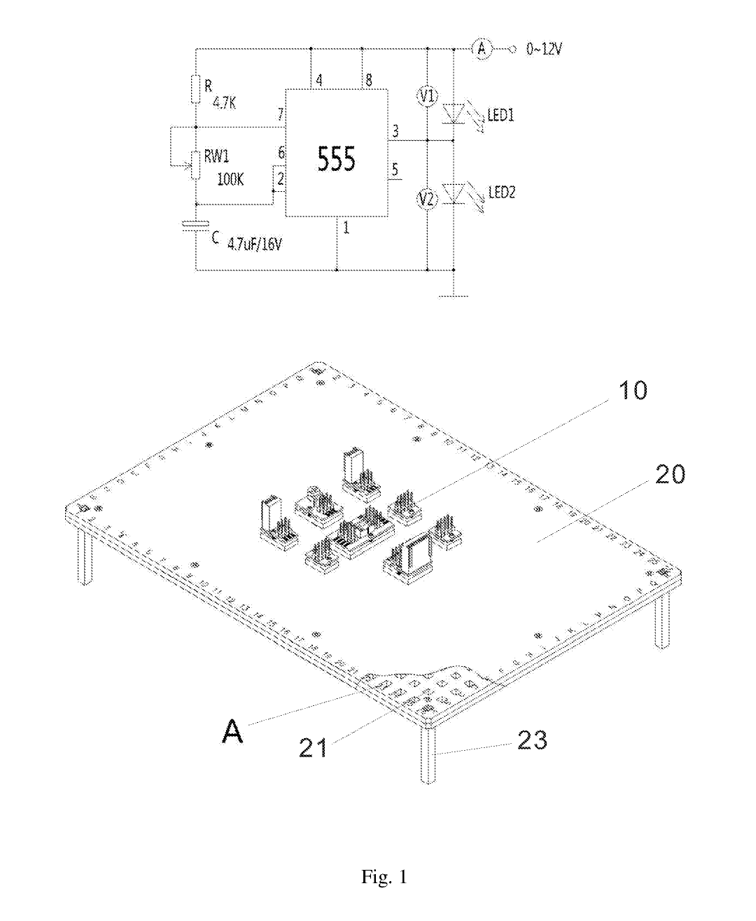

FIG. 1 is a module layout diagram showing a simple circuit experiment (555 flashlight circuit) accomplished by a PCB plug-in electronic module experiment device according to the present invention (the upper is a schematic diagram of the circuit). Wherein, the PCB plug-in electronic module experiment device according to the present invention comprises a PCB module plugboard 20 and a number of PCB plug-in electronic modules 100, wherein the PCB module plugboard 20 is provided with a plenty of jacks 21, each PCB plug-in electronic module 100 can be secured to or removed from any jack on the PCB module plugboard (via the plug, which will be described in detail below) and then multiple PCB plug-in electronic modules can be connected via connectors (such as wires or line rows), so that various electronic experiments can be accomplished.

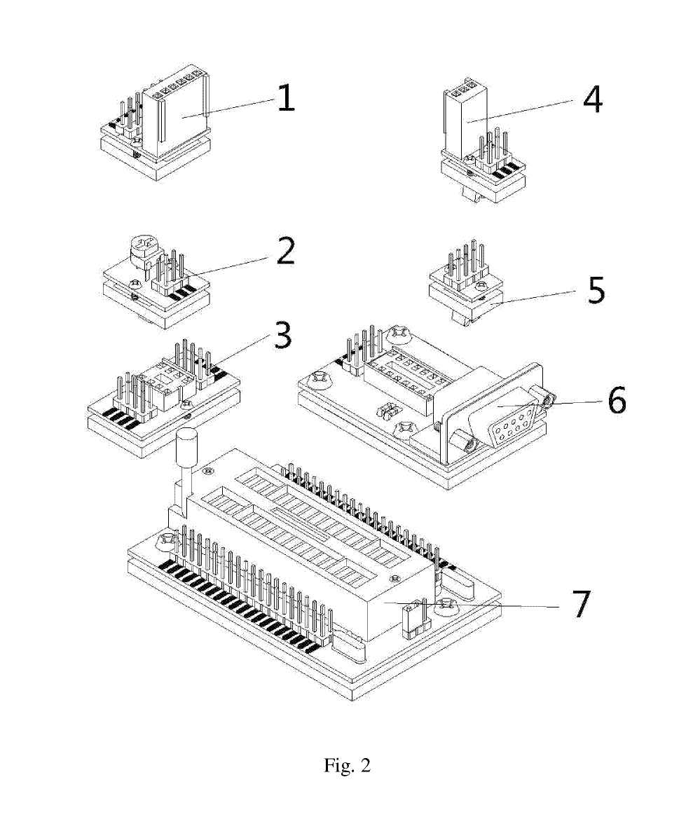

See FIG. 2, the PCB plug-in electronic modules 1 according to the present invention can be classified into two main types: one is the single multifunctional electronic module composed of a single component, such as the 6-hole socket module 1, the variable resistor module 2, the 8-pin IC socket module 3, the 3-hole socket module 4 and the node module 5 shown in FIG. 2 and so on, wherein the 6-hole socket module 1 is for the components such as integrated circuits with six pins or less, triodes with small or medium power, various diodes, resistors and capacitors; the variable resistor module 2 can substitute a small power potentiometer, a variable resistor and a constant resistor in a wide resistance range; beside receiving the 8-pin DIP integrated circuit, the 8-pin DIP integrated circuit socket module 3 also can be used for receiving a 4-pin optocoupler, a 6-pin optocoupler and two-port components like resistors, capacitors and diodes; the 3-hole socket module 4 is configured for receiving triodes with small or medium power, various diodes, resistors and capacitors; the node module 5 is configured for receiving 8 lines at the same time where the node refers to the public node in circuit and the module functions as a node is named as a node module, the node module is numbered as 5 in FIG. 2 and four node modules are utilized in FIG. 1.

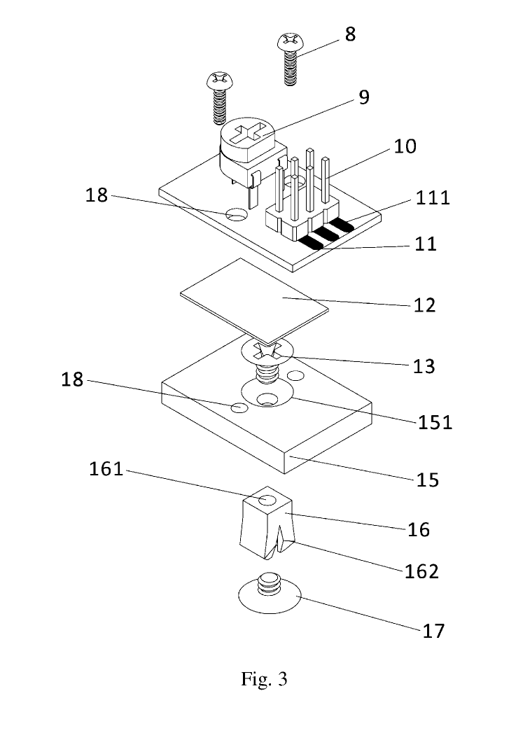

The other kind is the systematic functional module composed of multiple components or a node component substituting the public node, both the RS232 serial communication module 6 and 51 single chip socket module 7 in FIG. 2 are systematic functional modules composed of multiple components. As shown in FIG. 3, the number of the output terminals 10 of each component module is configured as twice the number of actual output terminals, facilitating the serial and parallel connection with the testing instruments and components. Apart from the use of plug-in output technique free of soldering, each output terminal is also provided with a bonding pad 111, configured for anti-interference experiments and the requirement of the reliable soldering connection.

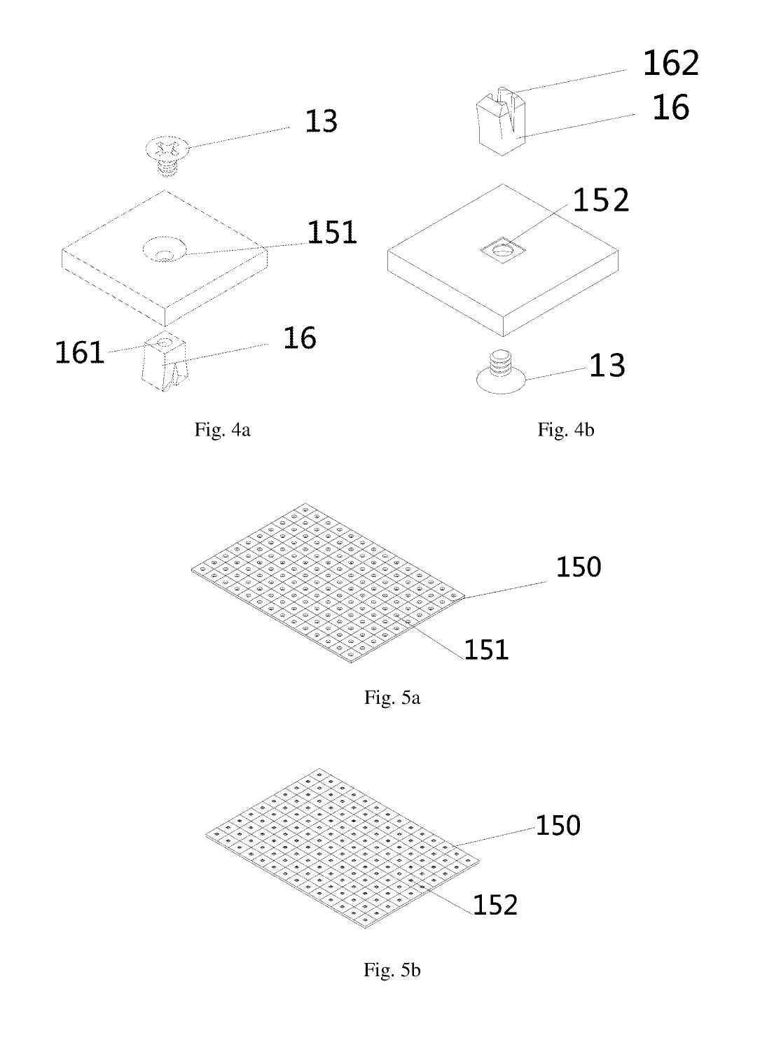

Below the specific structure of individual PCB plug-in electronic module 100 is demonstrated by taking the 8-pin IC socket module 3 as an example. As shown in FIG. 3, the PCB plug-in electronic module 100 comprises a PCB 11, a component 9 (a variable resistor in this embodiment) and a terminal socket 10 (preferred to be Dupont wire plug-in terminal socket) arranged on the PCB, a plug 16, and an insulation pad 15 arranged between the PCB 11 and the plug 16. The PCB adopts various connecting approaches to connect to the external, such as double quantity of plug-in terminals and corresponding bonding pads. See FIGS. 1-2, the double quantity of plug-in terminals facilitate the connection with testing instruments during the experiment and reduce the use of node modules. The bonding pads function to provide reliable soldering connection.

Wherein the plug 16 is suited to be inserted the jack 21 on the PCB module plugboard 20 and be stuck therein perfectly, for instance, when the jack is a square hole, the plug is a nylon plug well matched to the jack in shape. Each PCB plug-in electronic module 100 can be secured to any jack 21 on the PCB module plugboard 20 by inserting the plug 16 and removed therefrom by pulling out the plug; the plug 16 is a nylon plug well matched to the jack in shape. Both the PCB and the insulation pad are provided with at least two screw holes (18&18′) correspondingly, and thereby the PCB 11 can be fastened onto the top surface of the insulation pad 15 by the joint of screws 8 and the screw holes (18&18′). Meanwhile, the bottom surface of the insulation pad 15 is configured with a recess 152 for receiving the plug 16, the top surface of the insulation pad 15 is configured with a counterbore 151 for the socket head screw (see FIGS. 4a and 4b), and the recess 152 and the counterbore 151 are holed through, the top surface of the plug 16 is configured with a first through hole 161, the plug 16 is fastened to the bottom surface of the insulation pad 15 by inserting the socket head screw 13 into the counterbore 151 and the first through hole 161 orderly. Besides, so as to avoid the circuit of the PCB from being affected by the socket head screw 13, an insulator 12 (for example, an insulation sticker) is provided between the socket head screw 13 and the PCB 11.

Wherein, lower part of the plug 16 is provided with an opening in the shape of “reversed Y” and posses extending elastic, so that self-lock of the plug is realized due to big friction between the plug and the internal surface of the jack 21; besides, the internal surface of the lower end of the plug 16 is provided with screw guiding grooves 162, when each PCB plug-in electronic module is plugged into any jack of the PCB module plugboard via the plug, a fastening screw 17 may be inserted through the jack 21 and the screw guiding grooves 162, and thereby the plug 16 is fastened into the jack 21. The fastening screw 17 is required only when it is necessary to prevent the module from loosing. Generally, because lower part of the plug 16 is provided with an opening in the shape of “reversed Y” and posses extending elastic, which ensures big friction between the plug and the internal surface of the jack to realized self-lock thereof and facilitates the plug-in and pull-out operation and the replacement of the plug. The internal middle part of the lower end of the plug 16 is provided with two screw guiding grooves 162, when it is necessary to keep the validated circuit for a long time or to move it for a long distance, screws should be inserted from the bottom of the plug-in board and tightened in order to resist the possible vibration and loose so that the circuit system stays in effective contact and functions well.

Go on seeing FIG. 3, the assembly procedure of the PCB plug-in electronic module 100 is as follows: firstly, designing PCB circuit and determining the positions of the screw holes on the basis of the components, i.e. the variable resistor and Dupont wire plug-in terminal; mounting the component 9 (the variable resistor) and Dupont wire plug-in terminal 10 onto the manufactured PCB 11 and levelling off the bottom surface of the PCB to less than 2 mm; and then, cutting off a small piece of insulation pad 15 from an insulation blank sheet 150, each insulation pad is a flat pad in small size, and may be obtained by cutting from a general prefabricated module pad configured with equidistant counterbores on the top surface and equidistant square recesses on the bottom surface. For instance, as shown in FIGS. 5a-5b, the insulation pad according to the present invention can be obtained by cutting from the insulation blank sheet 150 where equidistant counterbores 151 are configured on the top surface and equidistant square recesses 152 are configured on the bottom surface of the sheet in advance, so as to facilitate the manufacture of the prefabricated module pad in different size and with different number of pins and allow the experimenter to manufacture insulation pads 15 in any size and with different number of plugs (optionally 1-4), and the space between feet is n times the space between the jacks. The procedure of manufacture is as follows: firstly, cutting a piece of insulation pad 15 from the insulation blank sheet 150 after determining the quantity and positions of the plugs according to the size of PCB, punching two screw holes (18&18′) on the insulation pad 15 through aiming at the screw hole positions on the PCB 11 by an electric drill, and then fastening the screw 13 into the hole 161 on the top of the nylon expansive plug 16 (shown in FIG. 4a) through the counterbore 151, the fit of the top plane of the plug 16 and the square recess 152 is shown in FIG. 4b; next, fastening the nylon plug 16 onto bottom surface of the insulation pad 15 by tightening the socket head screw 13, meanwhile, applying a small piece of insulation sticker 12 on the top of the socket head screw 13, lastly, fastening the PCB 11 onto the top surface of the insulation pad 15 by the screw 8.

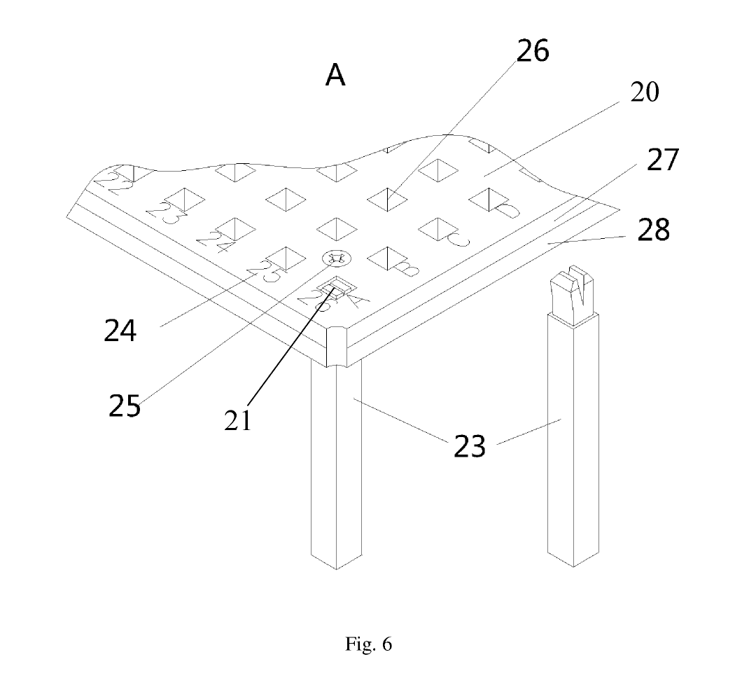

FIG. 6 is an enlarged partial diagram of the PCB module plugboard shown in FIG. 1. In the present embodiment, the PCB module plugboard is composed of an upper board 27 and a lower board 28 connected together by socket head screws 25 (thicker, stronger and capable of double side plug-in), there are four feet 23 under the PCB module plugboard 20 acting as supports, so that the stability of the board is ensured. The PCB module plugboard 20 is rectangle and a plenty of jacks 21 (which are square holes in the embodiment but they also can be any other shape) are arranged equidistantly thereon, forming an M*N matrix. A specific position can be indicated by setting codes 24 on the board 20, for instance, using letters A,B,C,D to indicate each line and using numbers 1,2,3,4 to indicate each column, so the position of the lowest and rightmost jack 21 is line A column 26.

It should be understood that the PCB module plugboard can be formed by piecing at least two PCB module plug sub boards provided with the jacks together. When conducting complex circuit experiments, two, three or more PCB module plugboards can be pieced together to form a big-sized PCB module plugboard, so as to realize the circuit experiment.

As shown in FIGS. 1 and 6, hereinafter a practical example is taken to demonstrate the principle and process of the PCB plug-in electronic module experiment device according to the present invention: for example, when the experiment device is utilized to conduct the 555 multivibrator LED flashing circuit experiment, the layout is formed by plugging PCB plug-in electronic modules into corresponding positions, wherein the upper diagram in FIG. 1 shows the principle of this experiment while the lower diagram shows the layout of the modules thereof. This layout comprises \textcircled{1} two 3-hole socket modules 4, wherein the one on the top left is for a 4.7K resistor R and the other on the bottom left is for a 4.7 uF/16V capacitor C. \textcircled{2}one 100K variable resistor RW1 module 2 arranged on the medium left. \textcircled{3}one DIP 8-pin integrated circuit socket module 3 arranged in the centre of the layout and for the 555 integrated circuit. \textcircled{4}one 6-hole socket module 1 arranged on the right and for two LEDs. Five of six components are multifunctional electronic modules each composed of a single component. Because the output terminals of each module are twice as much as the actual output terminals, corresponding connection between the two equipotential nodes on the left in the principle diagram and the three pin nodes of 555 multivibrator can be achieved without any supplement of node modules. Thereby, only three node modules are required, wherein the first one is placed on the bottom and acts as a grounding node, the second one is placed on the upper middle part and configured for connecting all the equipotential nodes of the eight pins of the 555 multivibrator, and the third one is placed in the upper right corner to connect to the power supply variable in the range of 0-12 V, the plug-in of these two analogue pointer voltmeters and a digital ammeter is realized via dedicated instrument testing wires one end of which is Dupont wire terminal. When all the connection is established, a check should be carried out on the experiment layout according to the circuit diagram, and then the power is applied and debugging of the experiment starts by raising the voltage and observing the instruments. Because of the similarity between the physical layout and the principle diagram, the circuit checking and troubleshooting are both facilitated, meanwhile, high success rate and efficiency are both achieved.

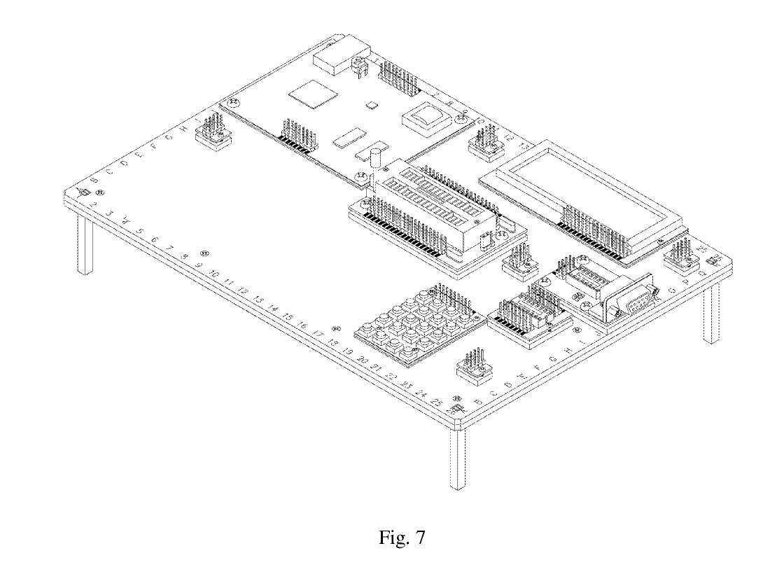

FIG. 7 is a module layout diagram showing a complex circuit experiment (a single chip microcontroller communication circuit) accomplished by a PCB plug-in electronic module experiment device according to the present invention (the schematic diagram of the circuit is not shown). Six systematic functional electronic modules each composed of multiple components and five node modules are utilized in this case, by correctly establishing the connections on the basis of the principle diagram, regulating parameters of components and the power supply and replacing modules via testing, complex experiments can be accomplished efficiently.

In conclusion, a systematic integrated circuit can be got in the following way: designing a PCB according to a small validated systematic functional circuit, mounting components on the PCB and conducting debugging thereon, and then mounting the insulation pad and plug. Various complex experiments can be accomplished by using multiple systematic modules of corresponding circuits, which is beneficial to novel electronic products development and participation of electronic design competitions. Especially, using highly precise tools to make PCB for experiment by themselves can greatly boost the speed of electronic products development and innovative personnel cultivation.

The PCB plug-in electronic modules can be plugged in the PCB module plugboard and stay thereon stably, both the position and the orientation are adjustable. Simple experiments mainly rely on these simplest component function modules. It is very expediently to lay out the circuits on the basis of principle diagrams, and using red wires to connect to the positive pole of the power supply while black wire to negative pole thereof makes the experiment layouts similar to the principle diagrams, which is beneficial to the beginners to check the circuits, to connect testing instruments and to remove the trouble, and thereby the success rate of experiments is prompted. Complex experiments mainly rely on these successfully tested systematic integrated modules with stable performance, which can reduce the quantity of wires and avoid signal interference, moreover, when some parameters need regulation, only relative modules needs to be modified, so that the efficient and success rate become extremely high. The PCB module plugboard can be arranged on various platforms with supports.

Multiple PCB module plugboards can be pieced together to form one board in big size for conducting circuit experiments with large or extra large systems, besides, the PCB module plugboard can be stacked on each other, so that the stability of the experiment system and the circuit contact can be ensured, and thereby the experiment can be accomplished successfully. The PCB module plugboard also provides the double-sided plug-in functions of modules for experiment circuit layout, and the spare sockets act as through hole for wires. When the experiment needs to move the experimental PCB module plugboard or to be accomplished in a long period, the plugs of these modules can be locked from the bottom of the PCB module plugboard by screws.

Under the support of the PCB plug-in electronic module experiment device, it is highly efficient to conduct either simple circuit experiments or complex circuit experiments. Therefore, apart from the increasing number of electronic amateurs, PCB techniques well bridge the experiments and products, which is beneficial to the products development and personnel cultivation on electronics, and in turn the electronic industry development of China.

Hereinbefore described are only preferred embodiments of the present invention. It should be noted that any modification or improvement carried out by the skilled in the art within the principle of the present invention should be taken as within the scope of protection of the present invention.

What is claimed is:

1. A PCB plug-in electronic module experiment device, comprising a PCB module plugboard and a number of PCB plug-in electronic modules, wherein the PCB module plugboard is provided with a plenty of jacks, and each PCB plug-in electronic module comprises a PCB, a component and a terminal socket arranged on the PCB, a plug, and an insulation pad arranged between the PCB and the plug; each PCB plug-in electronic module can be secured to any jack on the PCB module plugboard by inserting the plug and removed therefrom by pulling out the plug; the electrical connection among multiple PCB plug-in electronic modules can be established by connecting the terminal sockets via connectors, so that various electronic experiments can be accomplished.

2. The PCB plug-in electronic module experiment device according to claim 1, wherein the plug is matched to the jack in shape, and the lower part of the plug is provided with an opening in the shape of “reversed Y” and thereby posses extending elastic, so that self-lock of the plug is realized due to big friction between the plug and the internal surface of the jack.

3. The PCB plug-in electronic module experiment device according to claim 2, wherein both the PCB and the insulation pad are provided with at least two screw holes correspondingly, and the PCB is fastened onto the top surface of the insulation pad by the joint of screws and the screw holes.

4. The PCB plug-in electronic module experiment device according to claim 3, wherein a bottom surface of the insulation pad is configured with a recess for receiving the top end of the plug while a top surface of the insulation pad is configured with a counterbore for the socket head screw, and the recess and the counterbore are holed through; the top end of the plug is configured with a first through hole, the plug is fastened to the bottom surface of the insulation pad by inserting a socket head screw into the counterbore and the first through hole orderly;
between the socket head screw and the PCB is provided an insulation sticker to avoid the short circuit of the PCB caused by the socket head screw.

5. The PCB plug-in electronic module experiment device according to claim 4, wherein the internal surface of the lower end of the plug is provided with screw guiding grooves, when the PCB plug-in electronic module is plugged into the jack via the plug, a screw should be inserted from the other side of the jack through the screw guiding grooves and thereby lock the plug to the jack.

6. The PCB plug-in electronic module experiment device according to claim 5, wherein each insulation pad is a flat pad in small size, and may be obtained by cutting from a general prefabricated module pad which is configured with equidistant counterbores on the top surface and equidistant square recesses on the bottom surface.

7. The PCB plug-in electronic module experiment device according to claim 1, wherein the PCB adopts various connecting approaches to connect to the external, including double quantity of plug-in terminals and corresponding bonding pads.

8. The PCB plug-in electronic module experiment device according to claim 1, wherein each PCB plug-in electronic module may be a single multifunctional electronic module composed of a single component, a systematic functional electronic module composed of multiple components or a node module substituting a public node;
the single multifunctional electronic module may be but is not limited to a 3-hole socket module, a 6-hole socket module, a 8-pin IC socket module, a variable resistor module and a node module; the systematic functional electronic module may be but is not limited to a RS232 serial communication module and a 51 single chip microcontroller socket module.

9. The PCB plug-in electronic module experiment device according to claim 1, wherein the PCB module plugboard is rectangle, and a plenty of square jacks are located equidistantly on the PCB module plugboard, forming an M*N matrix.
